(19) United States
(12) Patent Application Publication
(10) Pub. No.: US 2026/0072833 A1
(43) Pub. Date: Mar. 12, 2026

(54) LOADING REGIONS OF FLASH TRANSLATION LAYER MAPPING TABLE IN A MEMORY SUB-SYSTEM

(71) Applicant: Micron Technology, Inc., Boise, ID (US)

(72) Inventors: Chenjie Zhou, Shanghai (CN); Shi Bo Zhang, Shanghai (CN); Liang Tang, Shanghai (CN); Yu Long Guan, Shanghai (CN)

(21) Appl. No.: 18/826,653

(22) Filed: Sep. 6, 2024

(51) Int. Cl. G06F 12/02; G06F 13/16

(52) U.S. Cl. CPC G06F 12/0292; G06F 13/1668

(57) ABSTRACT

A processing device in a memory sub-system receives a request to load a region of a plurality of regions of a translation layer mapping table from a non-volatile memory device to a volatile memory device and determines whether the region is in either a loaded or a loading state. Responsive to determining that the region is not in either the loaded or the loading state, the processing device initiates a region load operation to load the region from the non-volatile memory device to the volatile memory device.

### TECHNICAL FIELD

Embodiments of the disclosure relate generally to memory sub-systems, and more specifically, relate to loading regions of a flash translation layer (FTL) mapping table in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating loading regions of a flash translation layer (FTL) mapping table in a memory sub-system in accordance with some embodiments of the present disclosure.

FIG. 3 is a flow diagram of an example method of loading regions of a flash translation layer (FTL) mapping table in a memory sub-system in accordance with some embodiments of the present disclosure.

FIG. 4 is a sequence diagram illustrating a process for loading regions of a flash translation layer (FTL) mapping table in a memory sub-system in accordance with some embodiments of the present disclosure.

FIG. 5 is a block diagram of an example computer system in which embodiments of the present disclosure may operate.

### DETAILED DESCRIPTION

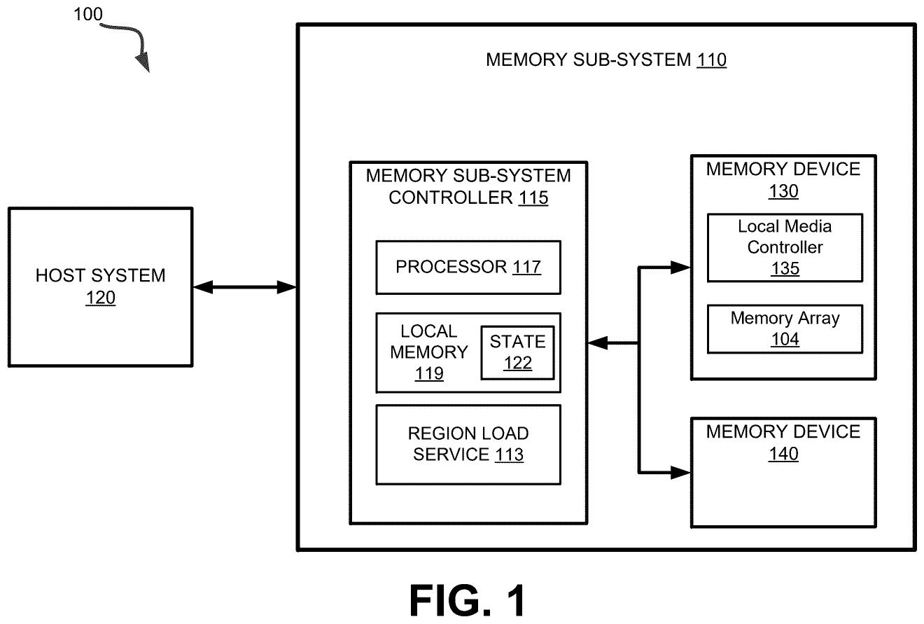

Aspects of the present disclosure are directed to loading regions of a flash translation layer (FTL) mapping table in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

One example of a memory sub-system is a solid-state drive (SSD) that includes one or more non-volatile memory devices and a memory sub-system controller to manage the non-volatile memory devices. The memory devices can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

Certain memory sub-systems use a Flash Translation Layer (FTL) to translate logical addresses of memory access requests, often referred to as logical block addresses (LBAs), to corresponding physical memory addresses. LBAs can be the logical addresses used by a host system for managing data, while the physical memory addresses represent the actual physical location of the memory device where the corresponding data is stored. The mappings of LBAs to physical memory addresses can be stored in one or more FTL mapping tables. In some instances, the FTL mapping tables can be referred to as a logical-to-physical (L2P) mapping tables storing L2P mapping information. The full FTL mapping table may generally be stored on a non-volatile memory device (e.g., NAND-type flash memory) in the memory sub-system. Since the access times for the non-volatile memory device may be slower, certain portions of the FTL mapping table (e.g., high priority or frequently accessed portions) may be stored in faster volatile memory (e.g., DRAM) of the memory sub-system, so that those portions (i.e., regions) can be accessed with lower latency.

After a power-cycle event in the memory sub-system, for example, the portions of the FTL mapping table stored in the volatile memory are lost and must be reloaded from the non-volatile memory. A region load service executed by the memory sub-system controller can manage the loading of certain regions of the FTL mapping table from the non-volatile memory to the volatile memory. The region load service can also be invoked in other situations that are not related to a power-cycle event, such as to load a region of the FTL mapping table that was not previously stored on the volatile memory (e.g., in response to a request from a host process or other process executed by the memory sub-system controller).

Such region load operations are not atomic, however, and challenges can arise when multiple requests to load the same region of the FTL mapping table into volatile memory are received concurrently or in close succession. For example, the region load service may receive a first request (e.g., from a first process) to load a given region of the FTL mapping table into volatile memory and begin a corresponding region load operation. Before the first region load operation is complete, the region load service may receive a second request (e.g., from a second process) to load the same region of the FTL mapping table into the volatile memory and begin a second region load operation to load a second instance of that region into the volatile memory. The first region load operation may complete before the second region load operation is completed. Once the first region load operation is completed, it is possible that some process makes an update to the first instance of the region of the FTL mapping table in the volatile memory (e.g., to change the mapping of the physical memory address for a given LBA). Once the second region load operation is completed, however, the region of the FTL mapping table will be overwritten with the second instance which does not include the update. Accordingly, the update will be lost and the FTL mapping table in the volatile memory is corrupted.

Aspects of the present disclosure address the above and other deficiencies by tracking the loading state when loading regions of the FTL mapping table in a memory sub-system. In one embodiment, the region load service maintains a state for each region of the FTL mapping table. In addition, to an “unloaded” state, which indicates that the region has not been loaded from the non-volatile memory to the volatile memory, and a “loaded” state, which indicates that the region has been loaded from the non-volatile memory to the volatile memory, the region load service can implement a new “loading” state. The “loading” state can be utilized when a region load operation has been initiated and remains in progress. When the region load operation has completed, the region load service can update the state to the “loaded” state. Thus, in the example scenario above, if a second request to load a given region of the FTL mapping table into the volatile memory is received, the region load service can check the state of that region and would determine that the region is in the “loading” state. In response to determining that the region is in the “loading” state, the region load service can discard the second request, thereby preventing the first instance of the region from being overwritten in the volatile memory.

Advantages of the approach described herein include, but are not limited to, improved performance in the memory sub-system. The implementation of the “loading” state serves as a safeguard against data corruption for the FTL mapping table and prevents operational errors by preserving any updates made to a previously loaded instance of a given region of the FTL mapping table. The “loading” state acts as a signal to prevent execution of concurrent region load operations that could potentially conflict, and also ensures that the region is fully loaded and updated before any read operations are performed.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the PCIe interface. The physical host interface provides an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes region load service 113 that manages the loading of regions of a flash translation layer (FTL) mapping table in memory sub-system 110. In one embodiment, the region load service 113 loads requested regions of the FTL mapping table from a non-volatile memory device, such as memory device 130, to a volatile memory device, such as memory device 140, responsive to a power-cycle event in memory sub-system 110 or a request from a requestor, such as host system 120 or another process executed by memory sub-system controller 115. The region load service 113 can manage these region load operations and track them using region load state information 122, which may be stored in local memory 119, for example. In other embodiments, the region load state information 122 can be stored elsewhere, such as on volatile memory device 140 or non-volatile memory device 130. For example, the region load service 113 can receive a request to load a region of the FTL mapping table from the non-volatile memory device 130 to the volatile memory device 140 and determine, using region load state information 122, whether the region is in either a “loaded” or a “loading” state. Responsive to determining that the region is not in either the “loaded” or the “loading” state (e.g., is in the “unloaded” state), the region load service 113 can initiate a region load operation to load the region from the non-volatile memory device 130 to the volatile memory device 140. If, however, the region load service 113 determines that the region is in either the “loaded” or the “loading” state, the region load service 113 can discard the request. Further details with regard to the operations of the region load service 113 are described below.

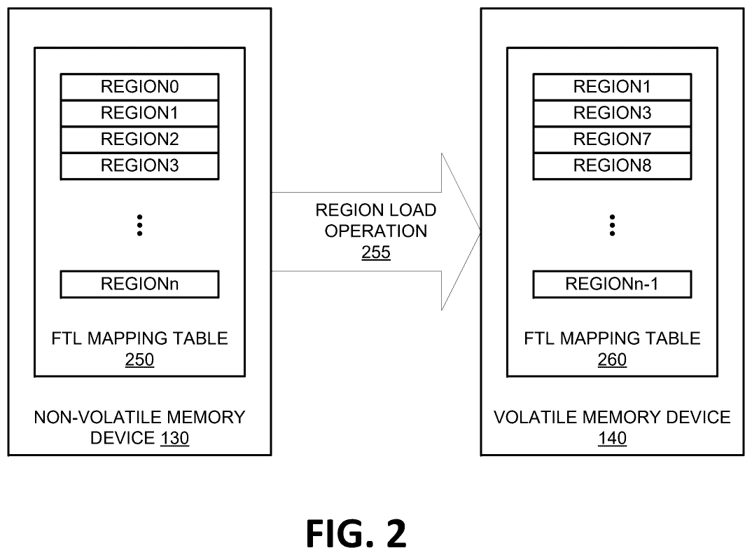

FIG. 2 is a block diagram illustrating loading regions of a flash translation layer (FTL) mapping table in a memory sub-system in accordance with some embodiments of the present disclosure. In one embodiment, flash-based FTL mapping table 250 is maintained on non-volatile memory device 130. FTL mapping table 250 includes a number of translation layer entries corresponding to regions (i.e., REGIONO-REGIONn) of a logical address space for the memory sub-system 110. In one embodiment, the logical address space is divided into a number of separate regions. Each region can be equally sized, although the last region might be smaller if the total size of the logical address space is not an integer multiple of the region size. Each of the regions can be further divided into a number of separate sub-regions. Each of the sub-regions can be equally sized, although the last sub-region of each region might be smaller if the region size is not an integer multiple of the sub-region size. Depending on the implementation, there can be any number of regions and/or sub-regions, and the regions and/or sub-regions can have different sizes. Each translation layer entry in FTL mapping table 250 includes the physical memory address of a corresponding logical block address. Depending on the implementation, the entries can correspond to regions, sub-regions, or some other segment of the logical address space. The entries in FTL mapping table 250, however, do represent the entirety of the logical address space.

Since the access times for the non-volatile memory device 130 may be slower, certain portions of the FTL mapping table 250 (e.g., high priority or frequently accessed portions) may be stored on the faster volatile memory device 140 (e.g., DRAM) as part of FTL mapping table 260. Those portions (i.e., regions) stored in FTL mapping table 260 can be accessed with lower latency from volatile memory device 140. After a power-cycle event in the memory sub-system 110, for example, the portions of the FTL mapping table 260 stored on the volatile memory device 140 are lost and must be reloaded from the non-volatile memory device 130. The region load service 113 executed by the memory sub-system controller 115 can manage the loading of certain regions of the FTL mapping table 250 from the non-volatile memory device 130 to the volatile memory device 140, such as by performing a region load operation 255. The region load service 113 can also be invoked in other situations that are not related to a power-cycle event, such as to load a region of the FTL mapping table 250 that was not previously stored on the volatile memory device 140 (e.g., in response to a request from a host process or other process executed by the memory sub-system controller 115). In the illustrated example, the FTL mapping table entries corresponding to only a subset of the regions of the logical address space have been loaded from FTL mapping table 250 into FTL mapping table 260 on volatile memory device 140 (i.e., REGION1, REGION3, REGION7, REGION8, REGIONn-1) via one or more region load operations 255. For example, multiple regions can be loaded to FTL mapping table 260 in a single region load operation 255, or there may be a separate region load operation 255 for each region.

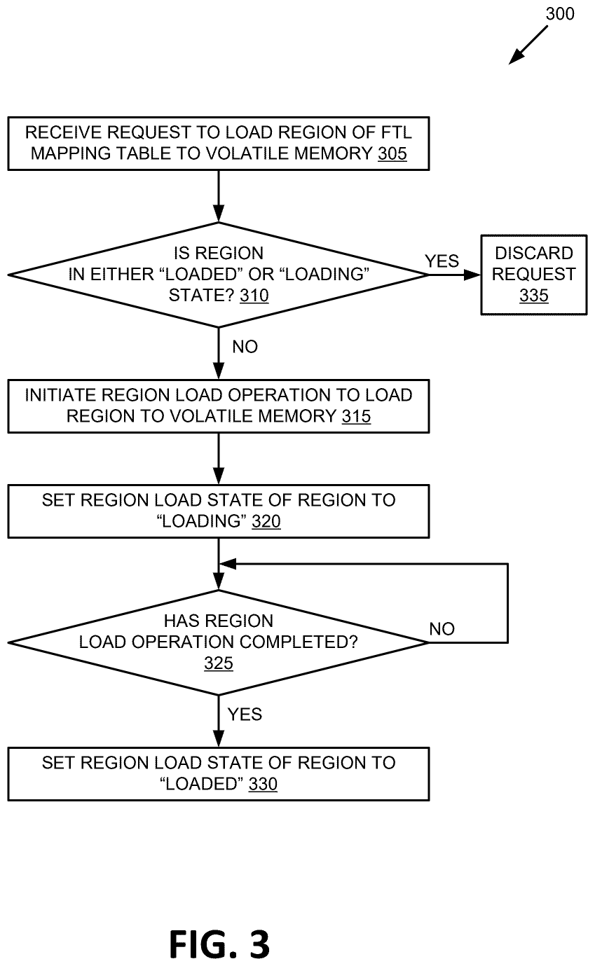

FIG. 3 is a flow diagram of an example method of loading regions of a flash translation layer (FTL) mapping table in a memory sub-system in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the region load service 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

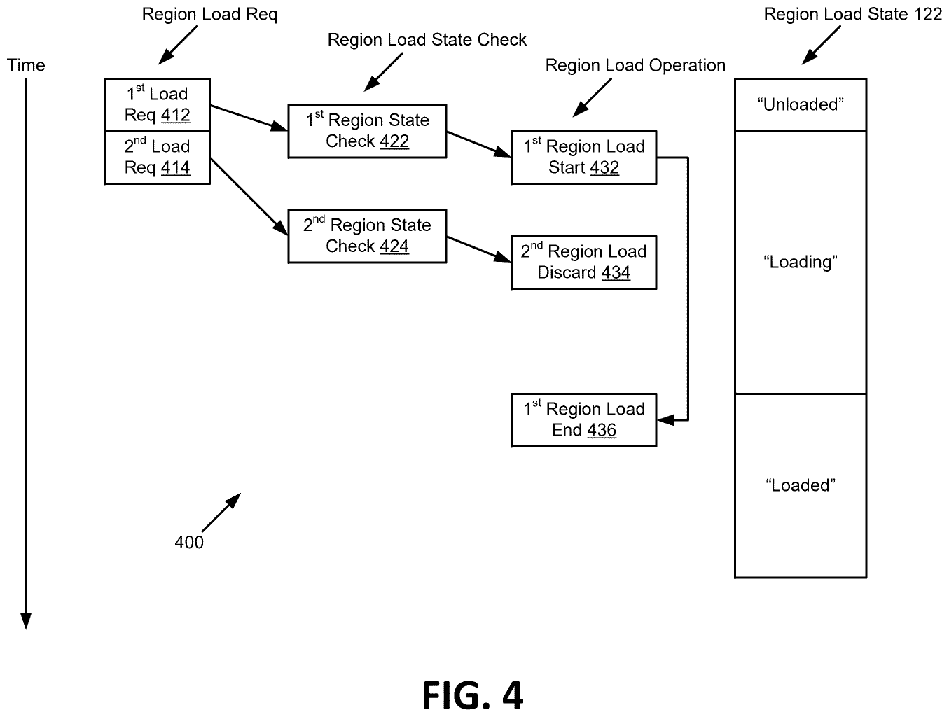

At operation 305, the processing logic (e.g., region load service 113) receives a request to load a region (e.g., REGION1) of the plurality of regions of a translation layer mapping table 250 from a non-volatile memory device 130 to a volatile memory device 140. As noted above, each region of the plurality of regions of the translation layer mapping table 250 comprises one or more entries mapping logical block addresses to physical memory addresses on the non-volatile memory device 130. The request can be received from any requestor, such as a process executed by host system 120 or other process executed by the memory sub-system controller 115. The request can follow power-cycle event in the memory sub-system 110, for example, when portions of the FTL mapping table 260 stored on the volatile memory device 140 are lost and must be reloaded from the non-volatile memory device 130, or can be unrelated to a power-cycle event, such as to load a region of the FTL mapping table 250 (e.g., a high priority or frequently accessed region) that was not previously stored on the volatile memory device 140. Examples of such requests are illustrated in the sequence diagram 400 of FIG. 4. FIG. 4 illustrates two separate requests 412 and 414 to load the same region (e.g., REGION1) from the FTL mapping table 250 on non-volatile memory device 130 to the FTL mapping table 260 on volatile memory device 140. The two requests 412 and 414 can be received simultaneously or otherwise close in time from separate requestors, for example.

Referring again to FIG. 3, at operation 310, the processing logic determines whether the region is in either a “loaded” or a “loading” state. The region load service 113 can determine the region load state using region load state information 122. As illustrated in FIG. 4, the region load state information 122 of each region can indicate that the corresponding region is in an “unloaded” state, a “loading” state, or a “loaded” state. In other embodiments, there can be different and/or additional region load states available. When a region is in the “unloaded” state, the region is represented by an entry in FTL mapping table 250 on non-volatile memory device 130, but is not present in FTL mapping table 260 on volatile memory device 140. When a region is in the “loading” state, the region is actively in the process of being loaded from FTL mapping table 250 on non-volatile memory device 130 to FTL mapping table 260 on volatile memory device 140 in response to a prior request. When a region is in the “loaded” state, the region is represented by an entry that has been fully loaded into FTL mapping table 260 on volatile memory device 140. The region load service 113 can update the region load state information 122 accordingly based on whether or not a corresponding region load operation 255 has been initiated and/or completed. To determine the current region load state of a given region, the region load service 113 can read the region load state information 122 for that region. These read operations are represented in FIG. 4 as region state checks 422 and 424. Region state check 422 can be performed in response to the first region load request 412 and region state check 424 can be performed in response to the second region load request 414.

Responsive to determining that the region is not in either the “loaded” or the “loading” state, at operation 315, the processing logic initiates a region load operation to load the region from the non-volatile memory device to the volatile memory device. Using the request 412 to load REGION1 as an example, the region load service 113 can perform region state check 422 and will determine that the current region load state 122 is “unloaded.” Thus, the region is not in either the “loaded” or the “loading” state. Accordingly, as illustrated in FIG. 4, the region load service 113 can initiate a corresponding region load operation 255 at a start time 432. In one embodiment, the region load operation 255 is performed using a direct memory access (DMA) operation to transfer the entry corresponding to REGION1 from FTL mapping table 250 on non-volatile memory device 130 to FTL mapping table 260 on volatile memory device 140.

Responsive to initiating the region load operation, 255 at operation 320, the processing logic sets a region load state of the region to the “loading” state. As illustrated in FIG. 4, the region load state information 122 for REGION1 is updated to “loading” concurrently with the start 432 of the region load operation 255.

At operation 325, the processing logic monitors the region load operation 255 to determine whether the region load operation 255 has completed and whether the region has been loaded from the non-volatile memory device 130 to the volatile memory device 140. The region load operation 255 has an associated transaction time that spans from the start 432 of the operation to an end 436 of the operation. The end 436 of the operation represents a time when the entirety of the entry representing REGION1 has been transferred (e.g., via the DMA operation) into the FTL mapping table 260 on volatile memory device 140.

Responsive to determining that the region load operation 255 has completed and that the region has been loaded from the non-volatile memory device 130 to the volatile memory device 140, at operation 330, the processing logic sets the region load state of the region to the “loaded” state. As illustrated in FIG. 4, the region load state information 122 for REGION1 is updated to “loaded”concurrently with the end 436 of the region load operation 255.

Responsive to determining at operation 310 that the region is in either the “loaded” or the “loading” state, at operation 335, the processing logic discards the request to load the region. Using the request 414 to load REGION1 as an example, the region load service 113 can perform region state check 424 will determine that the current region load state 122 is “loading.” Since request 414 was received after request 412 was received and after the region load operation 255 was initiated at a start time 432, the region load state 122 for REGION1 was previously updated to “loading.” In this situation, the region load service 113 will discard the second load request 414 relating to REGION1. Thus, the second load request 414 will not result in the first instance of REGION1 that was previously loaded into the volatile memory 140 in response to the first load request 412 being overwritten by a second instance of REGION1. Accordingly, in the event that any updates (e.g., changes to the mappings of the physical memory addresses for any LBAs) are made to the first instance of REGION1 after it is loaded into the volatile memory 140, those updates will be preserved and any data corruption will be prevented.

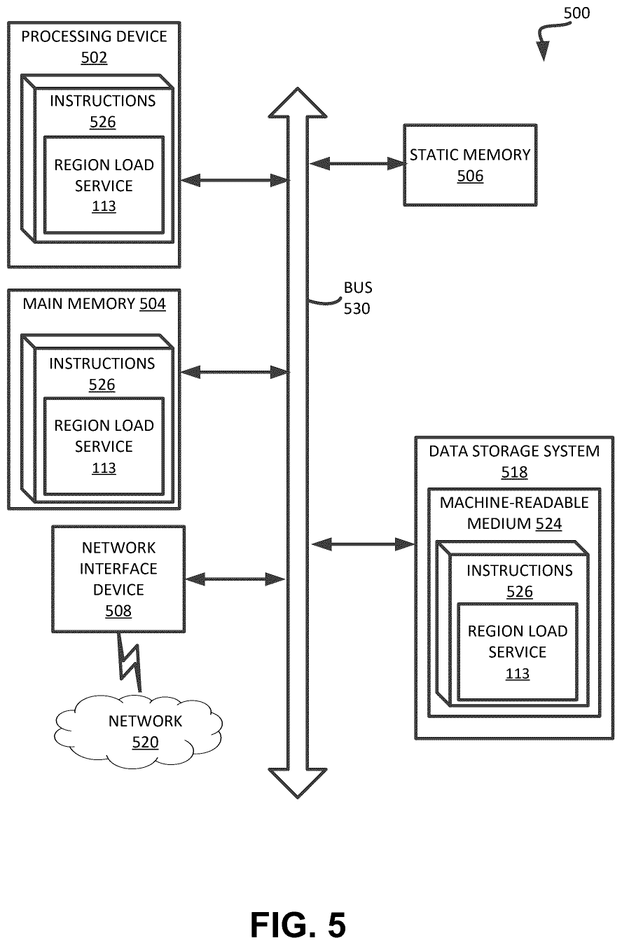

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1 and configured to perform operations corresponding to the region load service 113) that includes, is coupled to, or utilizes a memory sub-system (e.g., the memory sub-system 110 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the region load service 113 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A system comprising:
a non-volatile memory device storing a translation layer mapping table comprising a plurality of regions;
a volatile memory device; and
a processing device, operatively coupled with the non-volatile memory device and the volatile memory device, to perform operations comprising:
receiving a request to load a region of the plurality of regions of the translation layer mapping table from the non-volatile memory device to the volatile memory device;
determining whether the region is in either a loaded or a loading state;
responsive to determining that the region is in either the loaded or the loading state, discarding the request to load the region without initiating a duplicate region load operation for the region; and
responsive to determining that the region is not in either the loaded or the loading state, initiating a region load operation to load the region from the non-volatile memory device to the volatile memory device.

2. (canceled)

3. The system of claim 1, wherein the processing device is to perform operations further comprising:
responsive to initiating the region load operation, setting a region load state of the region to the loading state.

4. The system of claim 3, wherein the processing device is to perform operations further comprising:
monitoring the region load operation to determine whether the region load operation has completed and whether the region has been loaded from the non-volatile memory device to the volatile memory device.

5. The system of claim 4, wherein the processing device is to perform operations further comprising:
responsive to determining that the region load operation has completed and that the region has been loaded from the non-volatile memory device to the volatile memory device, setting the region load state of the region to the loaded state.

6. The system of claim 1, wherein each region of the plurality of regions of the translation layer mapping table comprises one or more entries mapping logical block addresses to physical memory addresses on the non-volatile memory device.

7. The system of claim 1, wherein the loading state indicates that the region is actively being loaded from the non-volatile memory device to the volatile memory device in response to a prior request.

8. A method comprising:
receiving a request to load a region of a plurality of regions of a translation layer mapping table from a non-volatile memory device to a volatile memory device;
determining whether the region is in either a loaded or a loading state;
responsive to determining that the region is in either the loaded or the loading state, discarding the request to load the region without initiating a duplicate region load operation for the region; and
responsive to determining that the region is not in either the loaded or the loading state, initiating a region load operation to load the region from the non-volatile memory device to the volatile memory device.

9. (canceled)

10. The method of claim 8, further comprising:
responsive to initiating the region load operation, setting a region load state of the region to the loading state.

11. The method of claim 10, further comprising:
monitoring the region load operation to determine whether the region load operation has completed and whether the region has been loaded from the non-volatile memory device to the volatile memory device.

12. The method of claim 11, further comprising:
responsive to determining that the region load operation has completed and that the region has been loaded from the non-volatile memory device to the volatile memory device, setting the region load state of the region to the loaded state.

13. The method of claim 8, wherein each region of the plurality of regions of the translation layer mapping table comprises one or more entries mapping logical block addresses to physical memory addresses on the non-volatile memory device.

14. The method of claim 8, wherein the loading state indicates that the region is actively being loaded from the non-volatile memory device to the volatile memory device in response to a prior request.

15. A non-transitory computer-readable storage medium comprising instructions that, when executed by a processing device, cause the processing device to perform operations comprising:
receiving a request to load a region of a plurality of regions of a translation layer mapping table from a non-volatile memory device to a volatile memory device;
determining whether the region is in either a loaded or a loading state;
responsive to determining that the region is in either the loaded or the loading state, discarding the request to load the region without initiating a duplicate region load operation for the region; and
responsive to determining that the region is not in either the loaded or the loading state, initiating a region load operation to load the region from the non-volatile memory device to the volatile memory device.

16. (canceled)

17. The non-transitory computer-readable storage medium of claim 15, wherein the instructions cause the processing device to perform operations further comprising:
responsive to initiating the region load operation, setting a region load state of the region to the loading state.

18. The non-transitory computer-readable storage medium of claim 17, wherein the instructions cause the processing device to perform operations further comprising:
monitoring the region load operation to determine whether the region load operation has completed and whether the region has been loaded from the non-volatile memory device to the volatile memory device.

19. The non-transitory computer-readable storage medium of claim 18, wherein the instructions cause the processing device to perform operations further comprising:
responsive to determining that the region load operation has completed and that the region has been loaded from the non-volatile memory device to the volatile memory device, setting the region load state of the region to the loaded state.

20. The non-transitory computer-readable storage medium of claim 15, wherein each region of the plurality of regions of the translation layer mapping table comprises one or more entries mapping logical block addresses to physical memory addresses on the non-volatile memory device.
